(19) United States
(12) Patent Application Publication
(10) Pub. No.: US 2007/0295807 A1
(43) Pub. Date: Dec. 27, 2007

(54) BIOMETRIC AND GEOGRAPHIC LOCATION SYSTEM AND METHOD OF USE

(76) Inventors: Kenneth M. Antos, Las Vegas, NV (US); David Becklean, Las Vegas, NV (US)

Correspondence Address: GREENBERG TRAURIG, 3773 HOWARD HUGHES PARKWAY, SUITE 500 NORTH, LAS VEGAS, NV, 89169, US

(21) Appl. No.: 11/426,885

(22) Filed: Jun. 27, 2006

(51) Int. Cl. G06K 5/00; G07F 19/00

(52) U.S. Cl. 235/382; 235/379

(57) ABSTRACT

Described is a hand-held device having a biometric reader and optional GPS functionality. The device acts as identification of the user. The device transmits the user's biometric data (e.g., fingerprint) to a central database of biometric information for verification of the user. The transmission may be wireless or via a wired or connected configuration. Upon verification, the central database transmits the verification to a participating business requiring the same to complete an immediate user transaction. If the transaction is a purchase, the central database also transmits bank account or credit card information of the user. The GPS functionality allows a user's location to also be verified for transaction requiring such information (e.g., online gaming).

### FIELD OF THE INVENTION

The embodiments of the present invention relate to an identification system. More particularly, the embodiments relate to a hand-held identification device relying on a user's one or more biometric identifiers and geographic location.

### BACKGROUND

Many activities require a participant or user to verify their identity. For example, accessing money from a bank or checking in for an airline flight. Conventionally, a participant uses a driver's license or passport as identification for such live activities. However, the explosion of Internet-transacted business has created new issues of identity verification. That is, conventional methods of identification are not useful over the Internet. So, Internet websites utilize usernames and passwords to identify users.

Whether identification is offered live or via the Internet, such conventional means of identification are often compromised by criminals. In a live environment, criminals may use another's credit card and not be required to show identification or may use a fake identification. Similar, over the Internet, criminals purchase items with stolen credit cards or credit card numbers and are often not required to present any form of identification (e.g., password or username). Moreover, should a criminal acquire another's credit card along with the credit card holder's username and password, the criminal can shop online until the credit card is maxed out.

There have been prior attempts utilizing biometric technology to overcome the shortcomings of the conventional identification means. For example, some businesses have installed biometric readers which can be used to identify customers having previously provided their corresponding biometric data. However, such systems are expensive for the businesses and only allow the purchasing business to benefit.

Thus, there exists the need for an identification system that is more cost effective for businesses and that can be more widely used by the public.

### SUMMARY

Accordingly a first hand-held device embodiment of the present comprises: a biometric reader; means for accessing, via said hand-held device, a remotely located database of at least stored biometric data accessible; and verification means operable to verify a user's biometric data acquired by said biometric reader matches the user's stored biometric data.

A first system embodiment of the present invention comprises: a hand-held device; at least one biometric reader integrated into said hand-held device; a remotely located database of at least stored biometric data accessible via said hand-held device; and verification means operable to verify a user's biometric data acquired by said biometric reader matches the user's stored biometric data.

A first method embodiment of the present invention comprises: acquiring biometric data of a user via a hand-held device maintained by the user; upon request, verifying the acquired biometric data matches stored biometric data of the user; and authorizing a transaction or action based on a verified match of the acquired biometric data and stored biometric data.

A geographic locator means may also be integrated into said hand-held unit to allow a user's location, in combination with their identification, to be verified. Such a locator is ideal for Internet applications which are concerned with a user's identification and location (e.g., online gaming) and as a replacement for time clocks.

Other variations, embodiments and features of the present invention will become evident from the following detailed description, drawings and claims.

### BRIEF DESCRIPTION OF THE DRAWINGS

FIG. 1 illustrates one configuration of a hand-held device according to a first embodiment of the present invention;

FIG. 2 illustrates a block diagram of internal components of the hand-held device of FIG. 1;

FIG. 3 illustrates a block diagram of a first system according to one embodiment of the present invention;

FIG. 4 illustrates a block diagram of a second system according to one embodiment of the present invention;

FIG. 5 illustrates a flow chart detailing one method of utilizing the hand-held device of FIG. 1; and

FIG. 6 illustrates a flow chart detailing a second method of utilizing the hand-held device of FIG. 1.

### DETAILED DESCRIPTION

For the purposes of promoting an understanding of the principles in accordance with the embodiments of the present invention, reference will now be made to the embodiments illustrated in the drawings and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention claimed.

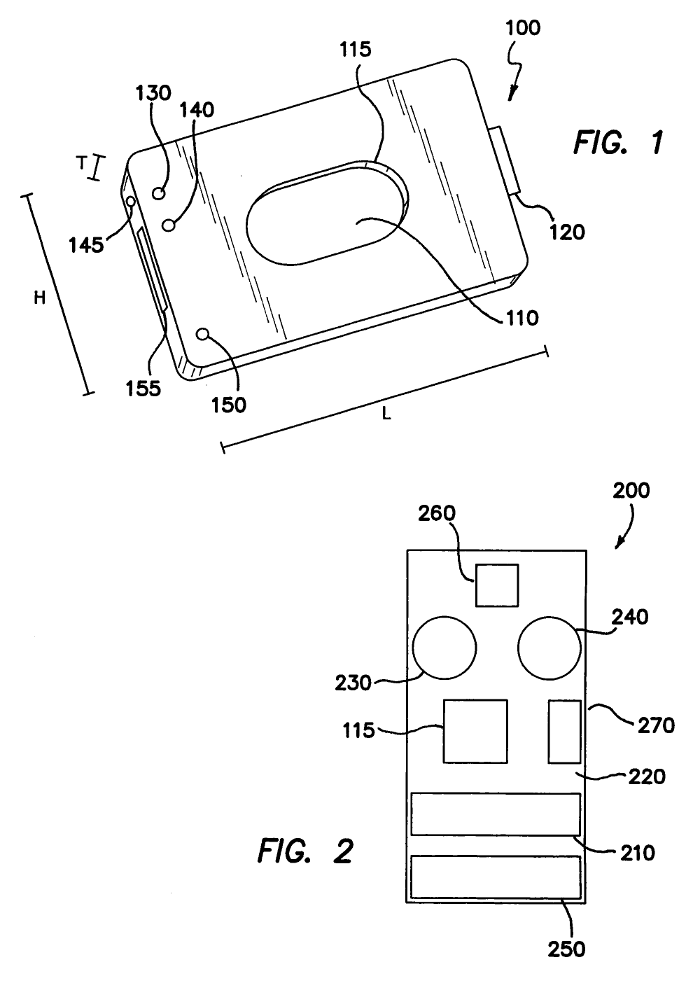

Initial reference is made to FIG. 1 illustrating a hand-held device generally referred to by reference numeral 100. Ideally, the hand-held device 100 has a front and rear surface area defined by the product of its height (H) and length (L) commensurate with a driver's license or credit card. A thickness, T, of the hand-held device 100 should be minimized to most closely resemble the look and feel of a driver's license or credit card. As electronic component technology advances, the inventors contemplate that the thickness, T, of the hand-held device 100 will continue to decrease. It should be understood that the actual dimensions of the hand-held device 100 are not critical.

The hand-held device 100 includes an integrated biometric reader 110. As shown, the biometric reader 110 is in the form of a fingerprint reader. The fingerprint reader 110 is depressed such that a small wall 115 defines a space for placement of a thumb. In other embodiments, the biometric reader may be an iris reader or other biometric device capable of biometrically identifying a user. Also, evident in FIG. 1 is a connector 120 for connecting the hand-held device 100 to a computer or similar device. As shown, the connector 120 is USB based but it can be a firewire connector, serial connector or any suitable connector capable of facilitating communication and/or data transfer between two electronic devices. Optionally, the hand-device 100 also includes a pair of LEDs 130, 140 for indicating whether an identification has been accepted or rejected. More specifically, illumination of green LED 130 confirms a positive identification and illumination of red LED 140 indicates a negative identification. Illumination of a third LED 150 indicates the hand-held device 100 is turned on. Shown is an optional port 145 for receipt of a male connector to charge the hand-held device 100 via a conventional electrical outlet. Transparent portion 155 facilitates the transmission and reception of wireless signals. While not shown, the hand-held device 100 may include a text or video screen suitable to interact with the user.

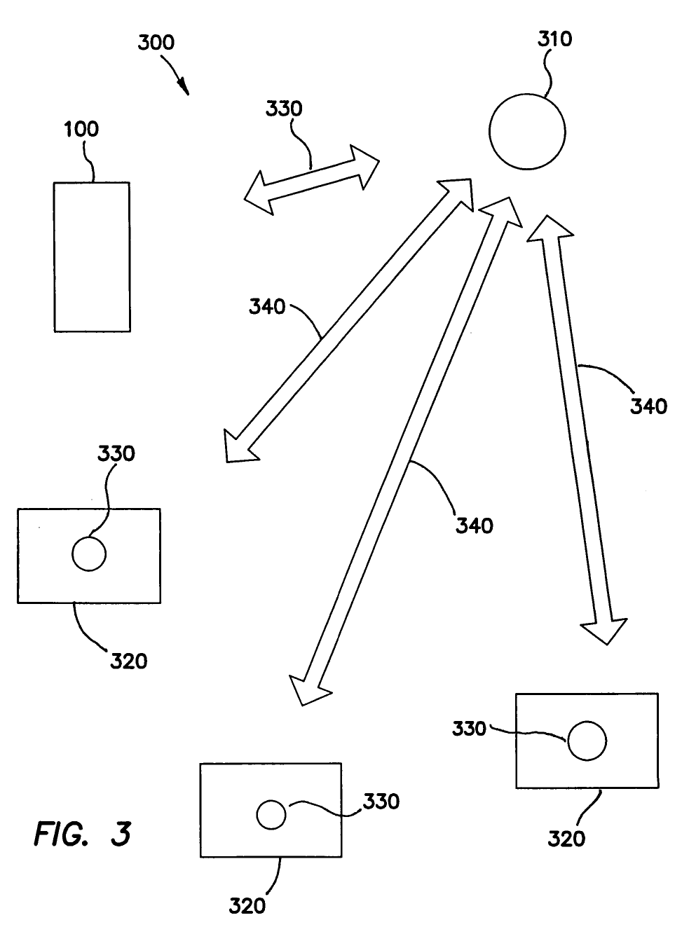

FIG. 2 shows a block diagram 200 of internal electronic components of the hand-held device 100. A first controller or microprocessor 210 controls operation of the biometric reader 110 comprising a scanner 115, digital camera or alternative fingerprint acquisition means. The microprocessor 210 may have embedded software or may communicate with separate software to operate the biometric reader 110. The microprocessor 210 is connected to a circuit board 220 that incorporates all electrical connections and electrical items (e.g., resistors, capacitors, etc.) necessary to facilitate operation of the hand-held device 100. In a first embodiment, a transmitter 230 is operable to wirelessly send biometric data acquired by the biometric reader 110 to a central database system 310 (shown in FIG. 3) including a database server having, in some embodiments of the present invention, processing power and operational software. Accordingly, in one embodiment, the central database system 310 causes the acquired biometric data to be compared to stored biometric data corresponding to the user. If a match occurs, a confirming signal is sent to the hand-held device 100 and received by receiver 240. Those skilled in the art will recognize that the transmitter 230 and receiver 240 may be replaced by a transceiver. In response to a match, LED 130 is illuminated indicating to the user that the match occurred. If no match occurs, a no match signal is sent to the hand-held device 100 and received by receiver 240. In response, LED 140 is illuminated indicating to the user that no match occurred.

In an alternative embodiment, the comparison of acquired biometric data and stored biometric data is accomplished at the hand-held device 100 rather than at the central database system 310. In this embodiment, upon acquiring the user's biometric data, the hand-held device 100 wirelessly requests the user's stored biometric data. If located, the central database system 310 transmits the user's located biometric data to the hand-held device 100 for comparison and verification. In this configuration, the hand-held device 100 incorporates the necessary processing power and operational software to verify matches and identify non-matches.

As set forth above, the hand-held device 100 may incorporate a different biometric reader, such as an iris reader. Nonetheless, the communication between the hand-held device 100 and the central database system 310 is as described with respect to the fingerprint reader 110, albeit utilizing iris data. To provide enhanced security, it is also conceivable that two biometric devices (e.g., fingerprint and iris reader) may be integrated into a single hand-held device.

A second controller or microprocessor 250 controls a GPS function operable to determine the location of the hand-held device, and hence the location of the user. Antenna 260 picks up low-power radio signals from GPS satellites. The microprocessor 250 utilizes the mathematical principle of trilateration to calculate its position based on the timing of the signals received from at least three separate GPS satellites. The technology facilitating GPS systems is well-known such that the intimate details need not be disclosed herein.

A power source 270, such as a battery, powers the components of the hand-held device 100. The power source 270 may comprise conventional batteries, rechargeable batteries, lithium batteries, watch batteries or any suitable substitute. However, ideally, the batteries are small to permit the hand-held device 100 to be fabricated having ideal dimensions. To maintain battery life, the hand-held device 100 may include a timing circuit designed to turn the hand-held device 100 off based on non-use. To further maintain the desired of the hand-held device 100, the functions of the first microprocessor 210 and the second microprocessor 250 may be combined into a single microprocessor. It is also conceivable that the hand-held device 100 may be solar powered by integrating a solar collector and corresponding storage means (not shown).

Now referring to FIG. 3, a system 300 for permitting the hand-held device 100 to be utilized is shown. The system 300 comprises at least one hand-held device 100, the central database system 310 and a plurality of commonly-owned banks 320. The hand-held device 100 is capable of bi-directional communication with the central database system 310 via wireless or wired connection 330. The central database system 310 is capable of bi-directional communication with each bank 320 via wireless or wired connection 340 and receivers located at the banks 320. The central database system 310 may also communicate with a central bank receiver (not shown) acting as a node which then connects to the specific bank 320 desired. Wireless communication between the central database system 310 and the hand-held device 100 and banks 320 is encrypted to prevent data from being compromised. It is also conceivable that the central database system 310 may communicate with the banks 320, and vice versa, via wired connections. As described below, with system 300, a user is able to utilize the hand-held device 100 at any of the commonly-owned banks 320 to identify himself or herself to a bank teller and transact business.

In system 300, once the acquired biometric data is verified against the stored user's biometric data, the hand-held device 100 notifies the user of a positive identification by means of illuminated LED 130 and, depending on the location of the verification, the central database system 310 or hand-held device 100 notifies the bank 320, via receivers, of the verification and the user's name and account number. Based on a link between the receiver and a teller's terminal, the verification then appears on a bank teller's computer screen along with the user's name and account number. Other information stored in the central database system 310 may also be transmitted to the teller's terminal A lack of verification notice may also be sent to the teller requiring the teller to seek conventional identification or causing the user to try using the hand-held device 100 again.

Providing the correct teller with verification and user information can be accomplished using various methods. A first method utilizes the GPS functionality of the hand-held device 100. Acting as a GPS receiver, the location of the hand-held device 100 can be determined and transmitted to the central database system 310. Based on a stored map system identifying the location of all the banks 320, the central database system 310 is able to identify the specific bank 320 to which the verification and accompanying user information should be transmitted. In one embodiment, at the specific bank 320, the verification signal is routed to the specific teller terminal based on a teller initially inputting the customer's name or other information which is then matched to the stored name corresponding to the verification. Should the match be verified prior to the teller entering the prompting data (e.g., customer name), the verification is held in a queue awaiting the prompt. The queue may be at the central database system 310 or at the specific bank 320 wherein the customer is located. In one embodiment, the teller terminal may pool the queue when ready for the verification.

A second method utilizes a customer accessible USB port 330 located at each teller station. With this method, the customer inserts the USB connector 120 of the hand-held device 100 into the USB port 330 with the user's finger on the fingerprint reader 100 thereby causing the acquired biometric data and a teller location and/or identification number to be transmitted to the central database system 310. Thereafter, the central database system 310 communicates with the teller terminal corresponding to the transmitted teller location.

While multiple commonly-owned banks 320 are used in an exemplary fashion, any business, including, but not limited to, hospitals, airport security check points, security access to buildings, DMVs, courts and retail outlets, requiring customer, client, user or participant identification is a candidate for the embodiments of the present invention.

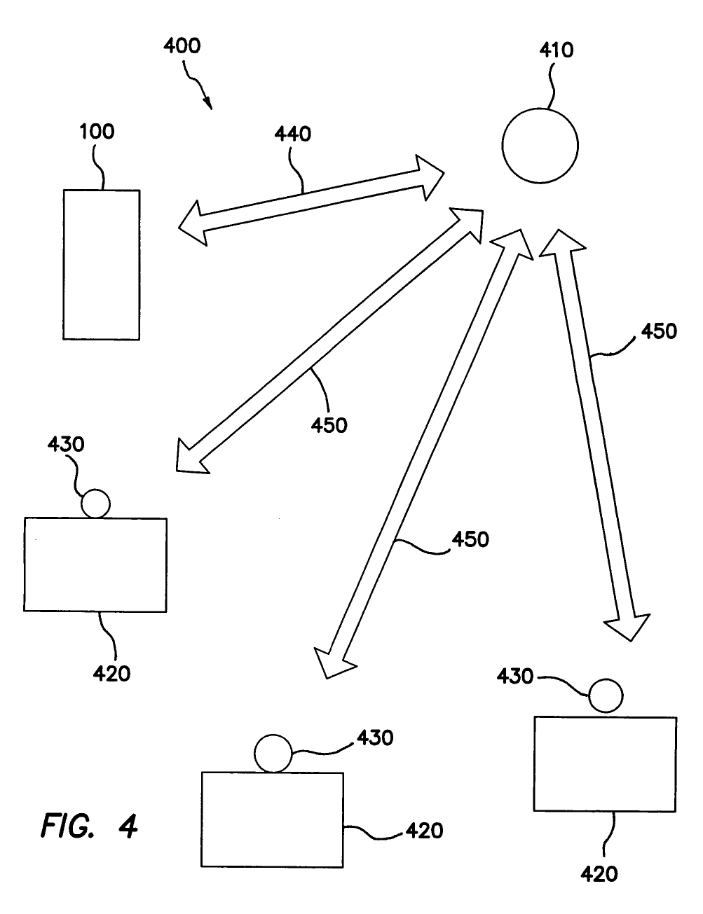

In another embodiment of the present invention as shown in FIG. 4, a system 400 includes a link between a central database system 410 and automated devices 420 such as ATMs, gasoline pumps or other self-service devices requiring user identification. Each automated device 420 includes a USB port 430 to receive the USB connector 120 of the hand-held device 100. Again, the customer inserts the USB connector 120 of the hand-held device 100 into the USB port 430 with the user's finger on the fingerprint reader 100 thereby causing the acquired biometric data and an automated device location or identification number to be transmitted via wireless or wired connections 440 to the central database system 410. Thereafter, the central database system 410 communicates via wireless or wired connections 450 with the automated device 420.

When being used to identify a user for a service requiring payment, the central database system 310, 410 may also transmit bank account or credit card information to a business cash register or cash terminal or directly to the automated device (e.g., gas pump). The payment for the goods or services is then withdrawn directly from the user's bank account or credit card as stored.

A tremendous benefit of the hand-held device 100 is its ability to eliminate Internet security issues. Currently, purchasing items online involves providing personal information including an address, social security number and bank account or credit card numbers. Unfortunately, not all websites provide the same level of security and thus personal information is routinely stolen and used to the detriment of the victim. As described below, the hand-held device 100 reduces the chance that personal information will be compromised.

In one example, in response to being prompted by a website to enter personal information, the customer connects his or her hand-held device 100 to his or her computer terminal by means of the USB connector 120 or via a wireless connection. The acquired biometric data is then transmitted to a central database system where it is verified against stored biometric data. The verification and accompanying required personal information is then transmitted to the website entity (e.g., website server) to process the order. The customer receives confirmation of the verification via the customer's computer terminal and/or the hand-held device 100. Importantly, the personal information does not need to be saved, stored or otherwise maintained by the website entity. By limiting personal information to the central database system, the likelihood of security breaches can be minimized as only one location needs to be protected rather than by each website server.

The hand-held device 100 is ideal for use with online gaming websites, pornographic websites or other age sensitive websites as well. The use of the hand-held device 100 not only verifies the identification of the user, but also verifies their age via information stored in the central database system. Should the user's age not meet the websites minimum, the website can implement procedures for denying the under-age user access.

Another situation that merits use of the hand-held device 100 is online gaming and other geographically restricted website access. Sports wagering is illegal in all states except Nevada. Therefore, the state of Nevada is legally able to conduct online sports wagering via a state Intranet. However, problematic issues surrounding the location of the users has caused concerns for the viability of such an Intranet. The hand-held device 100 eliminates the problem by verifying the identity and location of the user. The location may be verified by the GPS functionality of the hand-held device 100 or, if known, the physical location of the computer being used to place the wager. The GPS functionality is also useful to verify that online gamblers are located in a country (e.g., England) where online gaming is legal. Such a system allows the websites to limit access to legal players by age and location. Off track betting facilities may also benefit from use of the hand-held device 100.

An Intranet system may be facilitated by a system of kiosks, hotel room terminals or home computers configured to accept and record player wagers. Players first register by providing biometric data and personal information to the appropriate state or federal agency. Players then deposit monies into a designated account and download software to facilitate the wagering transactions. The use of hand-held device 100 allows gaming regulators and similar authorities to ensure the identity and location of the bettor. In a more widespread manner, a virtual casino, catering to any player possessing a hand-held device 100, may be implemented.

The hand-held device 100 may also be used to confirm the validity of employees punching a time clock. Often times, late employees will have other employees manually punch their time card so that the late employee is paid for a full day. Using the hand-held device 100 and a central database system permits an employer to verify the identity and location of the employee thereby eliminating the problem and the need for an expensive time clock at all. The hand-held device 100 is ideal for verifying the identity and location of remotely-positioned security guards who are trusted to guard individuals and/or facilities.

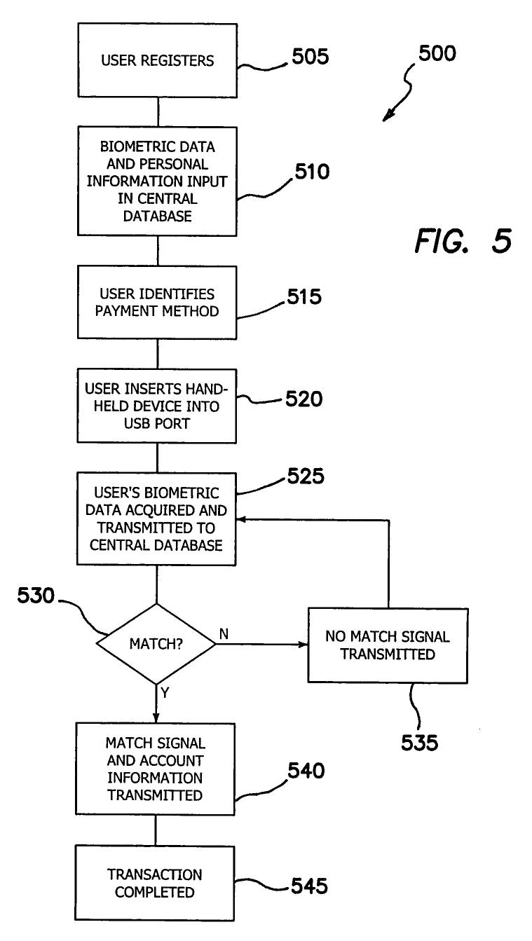

FIG. 5 shows a flow chart 500 detailing a methodology for utilizing the hand-held device 100 to purchase goods or services. Users of the hand-held devices 100 initially register by providing a sample fingerprint and verifiable personal information 505. The fingerprint data and required personal information is then input and stored in a central database system 510. Once registered, the player is free to use the hand-held device 100. After identifying goods and services, the user begins the checkout process by identifying a method of payment (e.g., debit or credit card) 515. Next, the user inserts the USB connector 120 of the hand-held device 100 into a USB port at a retail outlet check-out location or computer if purchasing goods or services online 520. The acquired biometric data is securely transmitted to the central database system 510 and compared to the user's stored biometric data 525. At 530, it is determined whether a match has occurred. If not, the database server transmits a no match signal to the hand-held device 100 and retail or online location 535. The flow chart 500 then loops back to 525. If a match has been verified, a match signal, along with the user's account information corresponding to the selected method of payment, is transmitted by the central database system 510 to the retail or online location 540. The match signal may also be transmitted to the hand-held device 100. The retail outlet cash resister or website server then uses the account number to process the payment such that the retailer or website entity receives its funds for the goods and/or services being purchased 545. Ideally, the personal information is not retained in any manner by the retail outlet or website.

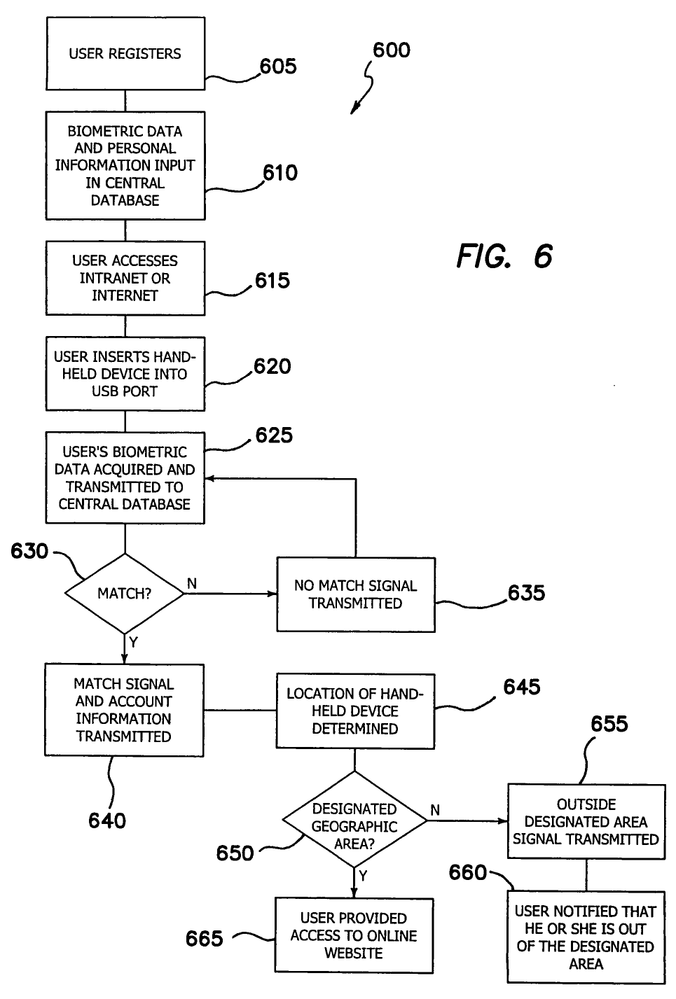

FIG. 6 shows a flow chart 600 detailing a gaming system requiring a user's age and location to be verified. Users of the hand-held devices 100 initially register by providing a sample fingerprint and personal information, including age 605. The fingerprint and required personal information, including the age, is then input and stored in a central database system 610. Once registered, the player is free to use the hand-held device 100. A user then uses a computer terminal to access an Intranet or Internet gaming website 615. The user inserts the USB connector 120 of the hand-held device 100 into a USB port at on the computer 620. The acquired biometric data is transmitted to the central database and compared to the user's stored biometric data 625. At 630, it is determined whether a match has occurred. If not, the central database system 610 transmits a no match signal to the hand-held device 100 and online location 635. The flow chart 600 then loops back to 625 for a user to retry entering his or her biometric data via the biometric reader 120 on the hand-held device 100. If a match has been verified, a match signal, along with the user's account information and age, is transmitted by the central database system 610 to the online location 640. The match signal may also be transmitted to the hand-held device 100. At 645, a location of the hand-held device 100 is determined by the GPS functionality of the hand-held device 100. It is then determined whether the location is within a pre-designated geographic area 650. If not, an outside area signal is transmitted to the website 655. The user is then notified via the computer terminal that he or she is outside of the acceptable geographic area 660. If it is determined that the player is within the pre-designated acceptable geographic area, the player is provided access to the gaming activities offered on the website 665. It should be understood that the biometric identity verification and GPS functionality may occur simultaneously depending on the microprocessor configuration.

One of the primary benefits of the embodiments of the present invention is that any number of businesses, whether brick and mortar or online, can access, for verification purposes, the same database of biometric data and personal information. In this manner, security over the information can be focused more readily and valuable storage space does not need to be managed by the businesses. The registration process comprises a user providing biometric data and personal information which is then stored in the central database system for access via the hand-held device 100.

While a dedicated hand-held device 100 has been described and illustrated herein, those skilled in the art will understand that the necessary components of the hand-held device 100 may be integrated into a cellular telephone, personal digital assistant, MP3 player or other commonly used hand-held device.

By integrating the GPS functionality, the hand-held device 100 may also be utilized to locate lost individuals (e.g., hikers, children, etc.). Indeed, the hand-held device 100 has unlimited uses, including those set forth hereinafter. The hand-held device 100 may be used as a medical alert that provides identification and location of a user in need of medical treatment, a passport at airport security check points to verify a user's identity and point of entry, a hospital patient identification and locator, a means for entering lock boxes and safety deposit boxes, a means for gaining access to machinery, including vehicles, a player tracking device and a keyless entry device. The hand-held device 100 may also be integrated into a cellular telephone to allow secured transactions over the phone.

In yet another use, multiple hand-held devices 100 may be able to track each other. Such an embodiment is ideal for family members to track one another or for parents to track their children. Only those with the proper identification, as authorized by the hand-held device 100, are able to track other users granting such permission. An optional display screen on the hand-held device 100 may facilitate such tracking.

Although the invention has been described in detail with reference to several embodiments, additional variations and modifications exist within the scope and spirit of the invention as described and defined in the following claims.

I claim:

1. A hand-held device comprising:
a biometric reader;
means for accessing a remotely located database of stored biometric data accessible via said hand-held device; and
verification means operable to verify a user's biometric data acquired by said biometric reader matches the user's stored biometric data.

2. The hand-held device of claim 1 wherein the biometric reader is a fingerprint or iris reader.

3. The hand-held device of claim 1 further comprising a GPS receiver.

4. The hand-held device of claim 1 further comprising a USB connector for insertion into a USB port.

5. The hand-held device of claim 1 wherein the means for accessing the remotely located database is a transmitter operable to transmit a wireless signal to said database.

6. The hand-held device of claim 1 further comprising processing power to compare the acquired biometric data to the stored biometric data.

7. The hand-held device of claim 1 wherein the hand-held device is used to facilitate online gaming.

8. An identity verification system comprising:
a hand-held device;
at least one biometric reader integrated into said hand-held device;
a remotely located database system operable to maintain a database of at least stored biometric data accessible via said hand-held device; and
verification means operable to verify a user's biometric data acquired by said biometric reader matches the user's stored biometric data.

9. The identity verification system of claim 8 further comprising a GPS receiver integrated into said hand-held device.

10. The identity verification system of claim 8 wherein the at least one biometric reader is a fingerprint or iris reader.

11. The identity verification system of claim 8 further comprising a USB connector integrated into said hand-held device.

12. The identity verification system of claim 8 wherein the database system is also capable of communicating with other electronic devices to confirm an identity of a user of the hand-held device and/or transmit user personal information to the other electronic devices.

13. The identity verification system of claim 12 wherein the other electronic devices comprise cash registers, computer terminals, ATMs, gas pumps, and kiosks.

14. The identity verification system of claim 12 wherein the user personal information comprises age, bank account numbers, credit card numbers, name, address, telephone number, e-mail address and location.

15. The identity verification system of claim 8 further comprising one or more automated electronic devices having a port operable to receive a connector integrated into said hand-held device such that the automated device may transmit the acquired biometric data to the database system.

16. The identity verification system of claim 15 wherein the automated electronic devices are computer terminals, ATMs, gas pumps, vending machines and kiosks.

17. A method of identifying a person comprising:
acquiring biometric data of a user via a hand-held device maintained by the user;
upon request, verifying the acquired biometric data matches stored biometric data of the user; and
authorizing a transaction or action based on a verified match of the acquired biometric data and stored biometric data.

18. The method of claim 17 further comprising, upon request, acquiring a location of the hand-held device.

19. The method of claim 17 further comprising transmitting the acquired biometric data from the hand-held device to a central database system for comparison with stored biometric data.

20. The method of claim 19 further comprising providing a connector on said hand-held device operable to insert into a port on a computer or other electronic devices in communication with said central database system.

21. The method of claim 17 further comprising transmitting stored biometric data from a central database system to the hand-held device for comparison with the acquired biometric data.

22. The method of claim 17 further comprising transmitting a signal corresponding to a verified match between the acquired biometric data and the stored biometric data to other electronic devices.

23. The method of claim 22 wherein the other electronic devices are cash registers, computer terminals, ATMs, gas pumps, and kiosks.

24. The method of claim 17 further comprising transmitting personal information of the user to other electronic devices upon verification of the user's identity.

25. The method of claim 24 wherein the other electronic devices are cash registers, computer terminals, ATMs, gas pumps, and kiosks.

26. A method of identifying a person comprising:
acquiring biometric data of a user via a hand-held device maintained by the user;
upon request, verifying the acquired biometric data matches stored biometric data of the user;
authorizing a transaction or action based on a verified match of the acquired biometric data and stored biometric data; and
transmitting personal information of the user required to fulfill the authorized transaction.

27. The method of claim 26 wherein the personal information includes bank or credit card account information.

28. The method of claim 26 further comprising locating a geographic position of the hand-held device.

29. The method of claim 26 further comprising wirelessly transmitting the personal information of the user.

30. A method of identifying a user of a website comprising:
acquiring biometric data of a user via a hand-held device maintained by the user, said hand-held device connectable to a computer being used to access the website;
transmitting said acquired biometric data to a central database system;
verifying a match between the acquired biometric data and biometric data of the user stored in said central database system;
transmitting to a website server a signal corresponding to a match between the acquired biometric data and biometric data of the user stored in said central database system; and
authorizing access to the website based on a verified match of the acquired biometric data and stored biometric data.

31. The method of claim 30 further comprising verifying a location of the hand-held device prior to authorizing access to the website based on a verified match of the acquired biometric data and stored biometric data.

32. The method of claim 31 wherein the website is a gaming website.
